(19) United States
(12) Patent Application Publication
(10) Pub. No.: US 2013/0215219 A1
(43) Pub. Date: Aug. 22, 2013

(54) MULTICASTING MULTIVIEW 3D VIDEO

(71) Applicants: Mohamed HEFEEDA, Doha (QA); Ahmed Hamza, Doha (QA)

(72) Inventors: Mohamed HEFEEDA, Doha (QA); Ahmed Hamza, Doha (QA)

(73) Assignee: QATAR FOUNDATION, Doha (QA)

(21) Appl. No.: 13/468,963

(22) Filed: May 10, 2012

(30) Foreign Application Priority Data
Feb. 17, 2012 (GB) 1202754.6
May 2, 2012 (GB) 1207698.0

(51) Int. Cl. H04N 13/00

(52) U.S. Cl. 348/42; 348/E13.001

(57) ABSTRACT

Apparatus, comprising a wireless transceiver to wirelessly communicate with multiple recipients, control logic coupled to the wireless transceiver to determine an amount of available bandwidth for multicasting multiple data streams for the recipients, the control logic to select an encoded data stream including data substreams relating to at least first and second video reference views and corresponding depth data for respective ones of the video reference views to transmit to a recipient via the wireless transceiver on the basis of the determined bandwidth.

### CROSS REFERENCE TO RELATED APPLICATIONS

This application claims foreign priority from GB Patent Application Serial No. 1202754.6 filed 17 Feb. 2012 and GB Patent Application No. 1207698.0 filed 2 May 2012.

### BACKGROUND

Multicasting multiple video streams over wireless broadband access networks enables the delivery of multimedia content to large-scale user communities in a cost-efficient manner. Three dimensional (3D) videos are the next natural step in the evolution of digital media technologies to be delivered in this way. In order to provide 3D perception, 3D video streams can contain one or more views which increase their bandwidth requirements. As mobile devices such as cell phones, tablets, personal gaming consoles and video players, and personal digital assistants become more powerful, their ability to handle 3D content is becoming a reality. However, channel capacity which is limited by the available bandwidth of the radio spectrum and various types of noise and interference, and variable bit rate of 3D videos means that multicasting multiple 3D videos over wireless broadband networks is challenging, both from a quality and power consumption perspective.

Typically, 3D video challenges the network bandwidth more than 2D videos as it requires the transmission of at least two video streams. These two streams can either be a stereo pair (one for the left eye and one for the right eye), or a texture stream and an associated depth stream from which the receiver renders a stereo pair by synthesizing a second view using depth- image-based rendering.

### SUMMARY

According to an example, there is provided a system and method for providing energy efficient multicasting of multiview video-plus-depth three dimensional videos to mobile devices.

According to another example, there is provided a system and method for providing high quality three dimensional streaming of video data over a wireless communications link to a mobile communications device.

According to another example, there is provided an apparatus, comprising a wireless transceiver to wirelessly communicate with multiple recipients, control logic coupled to the wireless transceiver to determine an amount of available bandwidth for multicasting multiple data streams for the recipients, the control logic to select an encoded data stream including data substreams relating to at least first and second video reference views and corresponding depth signals for respective ones of the video reference views to transmit to a recipient via the wireless transceiver on the basis of the determined bandwidth.

According to another example, there is provided a method for multicasting multiple video data streams over a wireless network, the method comprising encoding respective reference view texture and depth components of a video datastream to provide multiple compressed reference texture and depth substreams for the data stream representing respective different quality layers for the components of the data stream, the reference texture and depth components allowing the synthesis of multiple views for a video data stream which are intermediate to reference views, determining a maximum data capacity for a channel of the wireless network, for each video data stream, selecting substreams for reference texture and depth components from the layers which: maximise average quality of the multiple intermediate views according to a predetermined quality metric; maintain a bit rate which does not exceed the maximum data capacity.

According to an example, there is provided a computer program embedded on a non-transitory tangible computer readable storage medium, the computer program including machine readable instructions that, when executed by a processor, implement a method for multicasting multiple video data streams over a wireless network, comprising encoding respective reference view texture and depth components of a video datastream to provide multiple compressed reference texture and depth substreams for the data stream representing respective different quality layers for the components of the data stream, the reference texture and depth components allowing the synthesis of multiple views for a video data stream which are intermediate to reference views, determining a maximum data capacity for a channel of the wireless network, for each video data stream, selecting substreams for reference texture and depth components from the layers which: maximise average quality of the multiple intermediate views according to a predetermined quality metric; maintain a bit rate which does not exceed the maximum data capacity.

An apparatus and method according to examples can be used to provide 3D video data streams over broadband access networks. An access network can be a 4G network such as Long Term Evolution (LTE) and WiMAX for example. In an example, transmission of video data streams is effected such that the video quality of rendered views in auto-stereoscopic displays of mobile receivers such as smartphones and tablets is maximised, and the energy consumption of the mobile receivers during multicast sessions is minimised.

### BRIEF DESCRIPTION OF THE DRAWINGS

An embodiment of the invention will now be described, by way of example only, and with reference to the accompanying drawings, in which:

FIG. 1 is a block diagram of communications system according to an example;

FIG. 1a is a schematic block diagram of an apparatus according to an example;

FIG. 2 is a schematic view of a transmission system according to an example;

FIG. 3 illustrates calculation of profit and cost for texture component substreams according to an example;

FIG. 4 illustrates transmission intervals and decision points for two data streams according to an example;

FIGS. 5a and 5b illustrate quality values against number of streams and MBS area size respectively according to an example;

FIGS. 6a and 6b illustrate number of streams and MBS area size respectively against running time according to an example;

FIGS. 7a and 7b illustrate average running times for respective parameter values according to an example;

FIGS. 8a, 8b and 8c illustrate occupancy levels for a receiving buffer, a consumption buffer and an overall buffer level respectively according to an example;

FIGS. 9a, 9b and 9c illustrate average energy savings against number of streams, scheduling window duration, and receiver buffer size respectively according to an example; and

FIG. 10 is a schematic block diagram of an apparatus according to an example.

### DETAILED DESCRIPTION

It will be understood that, although the terms first, second, etc. may be used herein to describe various elements, these elements should not be limited by these terms. These terms are only used to distinguish one element from another. The terminology used herein is for the purpose of describing particular examples only and is not intended to be limiting. As used herein, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Three-dimensional (3D) display devices presenting three-dimensional video data may be stereoscopic or auto-stereoscopic. Whether stereoscopic or auto-stereoscopic, 3D displays typically require 3D video data that complies with a vendor- or manufacturer-specific input file format. For example, one 3D video data format comprises one or more 2D video data views plus depth information which allows a recipient device to synthesise multiple intermediate views. Such implicit representations of multiview videos therefore use scene geometry information, such as depth maps, along with the texture data.

Given the scene geometry information, a high quality view synthesis technique such as depth image-based rendering (DIBR) can generate any number of views, within a given range, using a fixed number of received views as input. This therefore reduces the bandwidth requirements for transmitting the 3D video, as a receiver need only receive a subset of the views along with their corresponding depth maps in order to be able to generate remaining views. Video-plus-depth representations also have the advantage of providing the flexibility of adjusting the depth range so that the viewer does not experience eye discomfort. In addition, the video can be displayed on a wide variety of auto-stereoscopic displays with a different number of rendered views.

Rendering a synthesised intermediate or virtual view from a single reference view and its associated depth map stream can suffer from disocclusion or exposure problems where some regions in the virtual view have no mapping because they were invisible in the (single) reference view. These regions are known as holes and require a filling technique to be applied that interpolates the value of the unmapped pixels from surrounding areas. This disocclusion effect increases as the angular distance between the reference view and the virtual view increases. In an example, synthesised intermediate views may be synthesised more correctly if two or more reference views, such as from both sides of the virtual view, are used. This is possible because areas which are occluded in one of the reference views may not be occluded in the other one.

It is possible to reduce the size of a transmitted video data stream more by exploiting the redundancies between the views of the multiview texture streams, as well as the redundancies between the multiview depth map streams, using the multiview coding (MVC) profile of H.264/AVC for example. This can be suitable for non-real-time streaming scenarios due to the high coding complexity of such encoders.

The quality of synthesized views is affected by the compression of texture videos and depth maps however. Given the limitations on the wireless channel capacity, it is therefore desirable to utilize channel bandwidth efficiently such that the quality of all rendered views at the receiver side is maximized.

According to an example, the textures and depth map substreams for views of multicast multiview video streams can be simulcast coded using the scalable video coding extension of H.264/AVC. Typically, two views of each multiview-plus-depth video are chosen for multicast and all chosen views are multiplexed over the wireless transmission channel. Joint texture-depth rate-distortion optimized substream extraction is performed in order to minimize the distortion in the views rendered at the receiver. Accordingly, examples described herein provide a substream selection scheme that enables receivers to render improved quality for all views given the bandwidth constraints of the transmission channel and the variable nature of the video bit rate.

In 4G multimedia services, subscribers are typically mobile users with energy-constrained devices. Therefore, an efficient multicast solution according to an example minimizes power consumption of receivers to provide a longer viewing time experience using energy-efficient radio frame scheduling of selected substreams. In an example, an allocation technique determines a burst transmission schedule to minimize energy consumption of receivers. Transmitting video data in bursts enables mobile receivers to turn off their wireless interfaces for longer periods of time, thereby saving on battery power. In an example, the best substreams are first determined and transmitted for each of multicast session based on a current network capacity. The video data is then allocated to radio frames and a burst schedule is constructed that does not result in buffer overflow or underflow instances at the receivers.

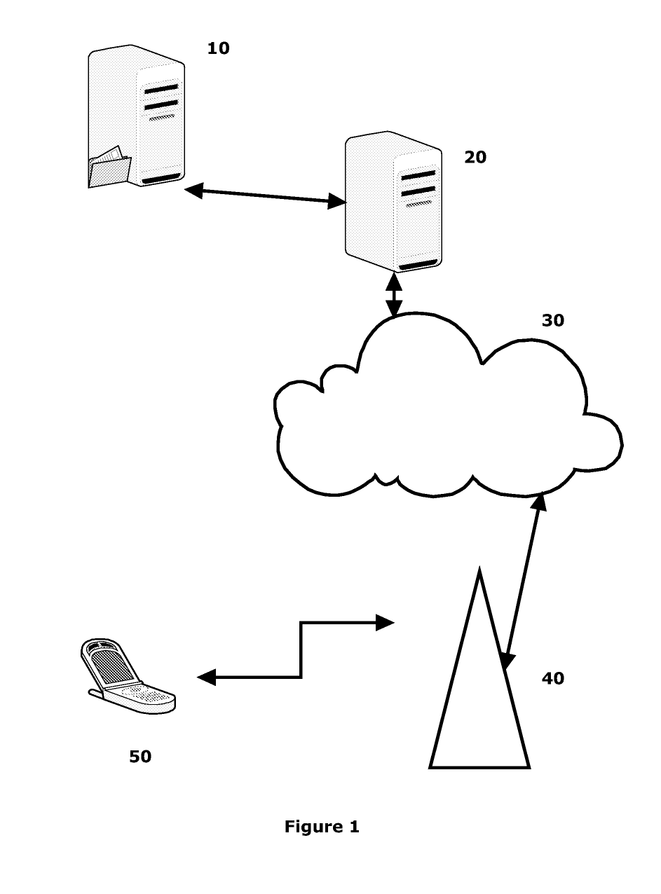

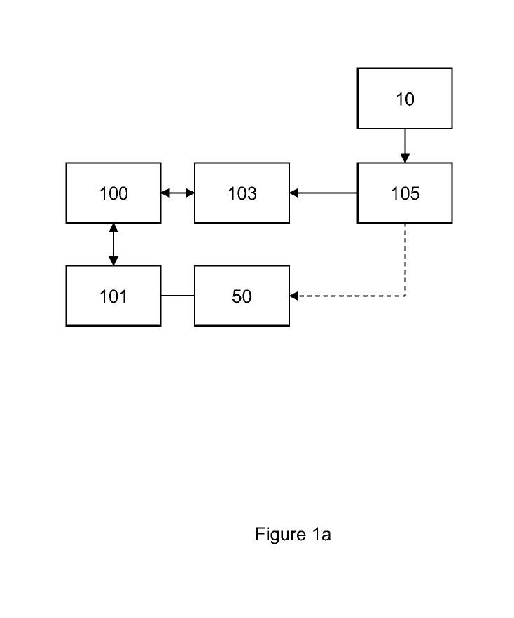

A communications system suitable for streaming video data streams over a wireless communications link is illustrated in FIG. 1. A wireless mobile video streaming system has four main components: a content server 10, an access gateway 20, connecting the content server 20 to the Internet or other network 30, a cellular base station 40, and a mobile communications device 50. Typically, network 30 will use internet protocol (IP) based communication protocols rather than a circuit-switched telephony service as in some cellular mobile communications standards.

Device 50 can include a stereoscopic or auto-stereoscopic display. In an example, an auto-stereoscopic display is used. 3D video data derived from a video data stream received by the device 50 over the network 30 can be displayed using the display.

FIG. 1a is a schematic block diagram of an apparatus according to an example. A wireless transceiver 100, such as a base station 40 of FIG. 1, is used to wirelessly communicate with multiple recipients 101. Each recipient 101 can be in possession of one or more devices 50. Typically, recipients are grouped into multicast sessions based on the requested video streams, and each group can contain one or more recipients interested in the same video stream. A control logic 103 is coupled to the wireless transceiver 100. Control logic 103 is operable to determine an amount of available bandwidth for multicasting multiple data streams for the recipients.

Video data 105 is provided, which can be stored on content server 10 for example. Data 105 is used to provide a video data stream to be transmitted to a device 50. In an example, data 105 includes data representing at least one reference view and corresponding depth data for a multi view plus depth video data stream. In an example, two reference view can be used, each of which has a corresponding depth component, thereby notionally resulting in four data substreams for the video data stream proper. Data representing the or each reference view and the depth data for the or each reference view are encoded to form multiple quality layers, such as multiple layers which comprise compressed versions of the reference view and the depth data for example. The corresponding encoded data can be stored on content server 10, or can be provided on-the-fly if practical. A video data stream transmitted to a device 50 is composed of multiple substreams, respective substreams relating to reference views and corresponding depth data streams for the reference views. In an example, each substream for an encoded data stream is an encoded data substream in which data is compressed compared to the original (source) reference and depth data. Each quality layer may comprise a different number of layers to other layers—that is, reference and/or depth data may be encoded into respective differing numbers of quality layers.

In an example, the control logic 103 selects an encoded data stream including data substreams relating to at least first and second video reference views and corresponding depth data for respective ones of the video reference views to transmit to a recipient via the wireless transceiver 100 on the basis of the determined bandwidth. An encoded data stream comprises encoded substreams for reference views and depth data.

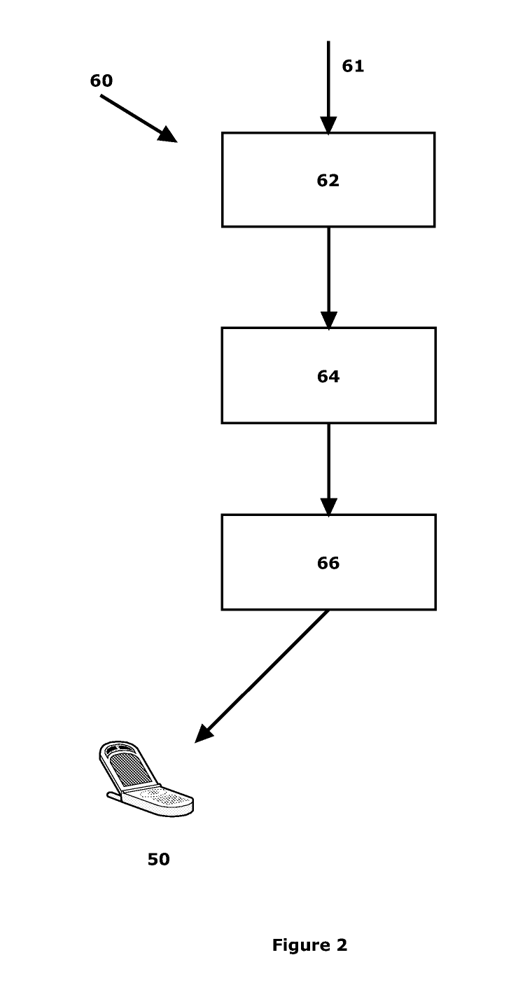

FIG. 2 illustrates a transmission system 60 suitable for encoding and transmitting video data over a wireless communications link to such a mobile communications device 50. The system 60 includes a receiver 62 operable to receive an input data stream 61 relating to a three-dimensional video signal, an encoder 64 operable to encode all or part of the video data stream 61 in a manner suitable for wireless transmission by a transmitter 66. The transmitter 66 is operable to transmit data to the mobile device 50 over an air interface of any appropriate type. For example, the air interface protocol may be 3G, 4G, GSM, CDMA, LTE, WiMAX or any other suitable link protocol.

The mobile communications device 50 periodically sends feedback about current channel conditions, e.g., signal-to-noise ratio (SNR) or link-layer buffer state, to the base station 40. Based on this feedback, the base station 40 changes the modulation and coding scheme so that the SNR is increased. This consequently results in a change in channel capacity. Knowing the current capacity of the channel, a base station can adapt the bit rate of the transmitted video accordingly.

Transmitting two views and their depth maps enables the display of a device 50 to render higher quality views at each possible viewing angle. Although it is possible to use three or more reference views to cover most of the disocclusion holes in the synthesized view, bandwidth consumption may limit the possibility of transmitting multiple views. With texture and depth information for two reference views, an aggregate rate for the four streams may exceed the channel capacity due to the variable bit rate nature of the video streams and the variation in the wireless channel conditions. Thus, in an example, allocation of system resources is performed dynamically and efficiently to reflect the time varying characteristics of the channel.

The principles of an aspect of the present invention are applicable to a wireless multicast/broadcast service in 4G wireless networks streaming multiple 3D videos in MVD2 representation. Examples of such a service include the evolved multicast broadcast multimedia services (eMBMS) in LTE networks and the multicast broadcast service (MBS) in WiMAX. MVD2 is a multiview-plus-depth (MVD) representation in which there are only two views. Therefore, two video streams are transmitted along with their depth map streams. As described, each texture/depth stream is encoded using a scalable encoder into multiple quality layers.

According to an example, time is divided into a number of scheduling windows of equal duration δ, i.e., each window contains the same number of time division duplex (TDD) frames. The base station allocates a fixed-size data area in a downlink subframe of each TDD frame. In the case of multicast applications, the parameters of the physical layer, e.g., signal modulation and transmission power, are fixed for all receivers. These parameters are chosen to ensure an average level of bit error rate for all receivers in the coverage area of the base station. Thus, each frame transmits a fixed amount of data within its multicast area. In the following, it is assumed that the entire frame is used for multicast data and the multicast area within a frame is referred to as a multicast block. According to an example, given a certain capacity of the wireless channel, a set S of 3D video streams in two-view plus depth (MVD2) format are transmitted to receivers with auto-stereoscopic displays, with each texture and depth component of every video stream encoded into L layers using a scalable video coder.

According to an example, for each video stream s ∈ S, an optimal subset of layers to be transmitted over the network is selected from each of the scalable substreams representing the reference views such that: 1) the total amount of transmitted data does not exceed the available capacity; and 2) the average quality of synthesized views over all 3D video streams being transmitted is maximized.

Assuming there are S multiview-plus-depth video streams where two reference views are picked for transmission from each video. In an example, all videos are multiplexed over a single channel. If each view is encoded into multiple layers, then at each scheduling window the base station needs to determine which substreams to extract for every view pair of each of the S streams. Let R be the current maximum bit rate of the transmission channel. For each 3D video, there are four encoded video streams representing the two reference streams and their associated depth map streams. Each stream has at most L layers. The value of L can be different for each of the four streams. Thus, for each stream, there are L substreams to choose from, where substream I includes layer I and all layers below it. Let the data rates and quality values for selecting substream I of stream s be rsl and qsl, respectively, where I=1, 2, . . . , L. For example, q₃₂ denotes the quality value for first enhancement layer substream of the third video stream. These values may be provided as separate metadata. Alternatively, if the scalable video is encoded using H.264/SVC and the base station is media-aware, this information can be obtained directly from the encoded video stream itself using the Supplementary Enhancement Information (SEI) messages for example.

In an example, texture or depth streams will not have the same number of layers. This provides flexibility when choosing the substreams that would satisfy the bandwidth constraints. In an example, an equal number of layers for left and right texture streams, as well as for the left and right depth streams is provided. Moreover, corresponding layers in the left and right streams can be encoded using the same quantization parameter (QP). This enables corresponding layers in the left and right texture streams to be treated as a single item with a weight (cost) equal to the sum of the two rates and a representative quality equal to the average of the two qualities. The same also applies for left and right depth streams.

Let I be the set of possible intermediate views which can be synthesized at the receiver for a given 3D video that is to be transmitted. The goal is to maximize the average quality over all i ∈ I and all s ∈ S. Thus, substreams are chosen such that the average quality of the intermediate synthesized views between the two reference views is maximized, given the constraint that the total bit rate of the chosen substreams does not exceed the current channel capacity. Let xₛₗ be binary variables that take the value of 1 if substream I of stream s is selected for transmission and 0 otherwise. Texture and depth streams are denoted with superscripts t and d respectively. If the capacity of the scheduling window is C and the size of each TDD frame is F, then the total number of frames within a window is P=C/F. The data to be transmitted for each substream can thus be divided into bₛₗ=┌rₛₗ·δ/F┐ multicast blocks, where rₛₗ is the average bit rate for layer I of stream s. In an example, a linear virtual view distortion model can be used to represent the quality of the synthesized view in terms of the qualities of reference views. Based on this model, the quality of a virtual view can be approximated by a linear surface in the form given in Eq. (1), where Qᵥ is the average quality of the synthesized views, Qₜ is the average quality of the left and right texture references, Q_{d} is the average quality of the left and right references depth maps, and α, β, and C are model parameters. The model parameters can be obtained by either solving three equations with three combinations of Qᵥ, Qₜ, and Q_{d}, or more accurately using regression by performing linear surface fitting.

Qᵥ=αQₜ+βQ_{d}+C. (1)

Consequently, there exists an optimization problem (P1). In this formulation, constraint (P1a) ensures that the chosen substreams do not exceed the transmission channel's bandwidth. Constraints (P1b) and (P1c) enforce that only one substream is selected from the texture references and one substream from the depth references, respectively.

$$\begin{matrix}Maximize \frac{1}{S} {\sum }_{s ∈ S} \frac{1}{I} {\sum }_{i ∈ I} ( {α}_{s}^{i} {\sum }_{l = 1}^{L} {x}_{sl}^{t} {q}_{sl}^{t} + {β}_{s}^{i} {\sum }_{I = 1}^{L} {x}_{sl}^{d} {q}_{sl}^{d} ) & ( P1 ) \\ such that {\sum }_{s = 1}^{S} ( {\sum }_{l = 1}^{L} {x}_{sl}^{t} {b}_{sl}^{t} + {\sum }_{l = 1}^{L} {x}_{sl}^{d} {b}_{sl}^{d} ) \leq P & ( P1a ) \\ {\sum }_{l = 1}^{L} {x}_{sl}^{t} = 1 , \\ s = 1 , … , S , & ( P1b ) \\ {\sum }_{l = 1}^{L} {x}_{sl}^{d} = 1 , \\ s = 1 , … , S , & ( P1c ) \\ {x}_{sl}^{t} , {x}_{sl}^{d} ∈ \{ 0 , 1 \} & ( P1d )\end{matrix}$$

In an example, a substream selection process can be mapped to a Multiple Choice Knapsack Problem (MCKP) problem in polynomial time. In an MCKP instance, there are M mutually exclusive classes N₁, . . . , N_{M} of items to be packed into a knapsack of capacity W. Each item j∈ Nᵢ has a profit and a weight wᵢⱼ. The problem is to choose exactly one item from each class such that the profit sum is maximized without having the total sum exceed the capacity of the knapsack.

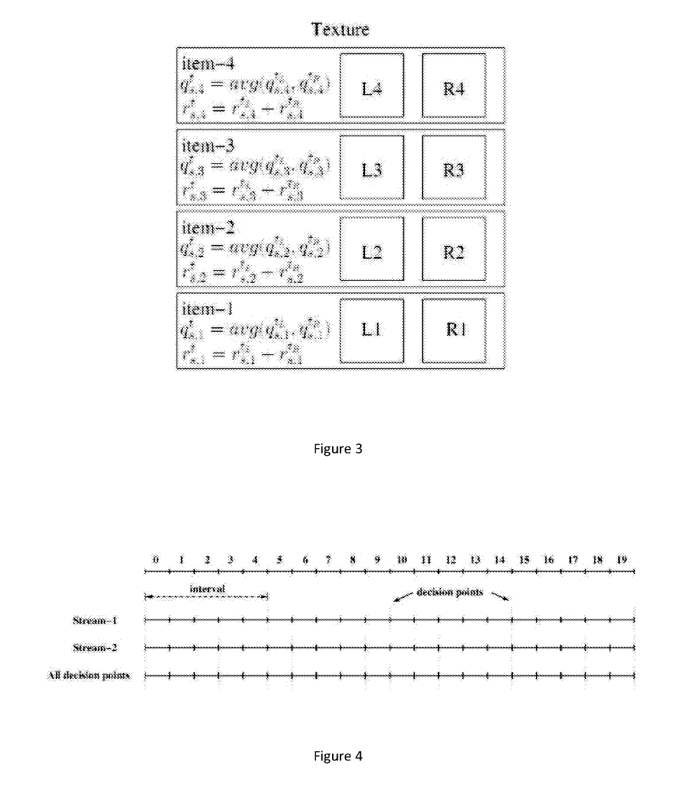

The substream selection problem can be mapped to the MCKP in polynomial time in an example as follows. The texture/depth streams of the reference views of each 3D video represent a multiple choice class in the MCKP. Substreams of these texture/depth reference streams represent items in the class. The average quality of the texture/depth reference views substreams represent the profit of choosing an item and the sum of their data rates represents the weight of the item. FIG. 3 demonstrates this mapping for the texture component of videos in a set of 3D videos according to an example, where both the texture and the depth streams are encoded into 4 layers. For example, item-2 in FIG. 3 represents the second layer in both left and right (first and second respectively) reference texture streams with a cost equal to the sum of their data rates and a profit equal to their average quality. The 3D video is represented by two classes in the MCKP, one for the texture streams and one for the depth map streams. Finally, by making the scheduling window capacity the knapsack capacity, a MCKP instance exists. Thus, the problem is NP-hard, i.e., an optimal solution to the problem would yield an optimal solution to the MCKP. Moreover, given a set of selected substreams from the components of each 3D video stream, this solution can be verified in O(SL)steps. Hence, a substream selection problem is NP-complete.

In an example, determining, for example, a luminance value for a portion of a synthesized intermediate view includes determining the peak-to-signal noise ratio (PSNR) of the luminance component of the corresponding frames in order to determine the quality of an encoded and/or distorted video stream with respect to the original stream.

Examples of the present invention may address the 3D video multicasting problem using enumerative techniques such as branch-and-bound or dynamic programming. These techniques are typically implemented in most of the available optimization tools. However, these techniques have, in the worst case, running times which grow exponentially with the input size. Thus, this approach is not suitable if the problem is large. Furthermore, optimizations tools may be too large or complex to run on a wireless base station. In one example, an approximation technique which runs in polynomial time and finds near optimal solutions is used. Given an approximation factor ∈, an approximation technique operates to find a solution with a value that is guaranteed to be no less than (1−∈) of the optimal solution value, where ∈ is a small positive constant.

To solve a substream selection problem instance, a single coefficient is calculated for the decision variables of each component of each video stream in the objective function. For variables associated with the texture component \hat{q}^{t}ₛₗ=qₛₗ^{t}Σ_{i∈1}αₛⁱ, and the coefficient for depth component variables is âₛₗ^{d}=qₛₗ³Σ_{i∈1} βₛⁱ.

An upper bound on the optimal solution value is then found in order to reduce the search space. This is achieved by solving the linear program relaxation of the multiple choice knapsack problem (MCKP). A linear time partitioning technique for solving the LP-relaxed MCKP exists. This technique does not require any pre-processing of the classes, such as expensive sorting operations, and relies on the concept of dominance to delete items that will never be chosen in the optimal solution. In the present application, a class in the context of the MCKP represents one of the two components (texture or depth) of a given 3D video, where each component is comprised of the corresponding streams from the two reference views. It should also be noted that m denotes the number of classes available at a particular iteration, since this changes from one iteration to another as the technique proceeds. Thus, at the beginning of the technique we have m=2S classes.

An optimal solution vector, x^{LP} to the linear relaxation of the MCKP satisfies the following properties in an example: (1) x^{LP} has at most two fractional variables; and (2) if x^{LP} has two fractional variables, they must be from the same class. When there are two fractional variables, one of the items (substreams) corresponding to these two variables is called the split item, and the class containing the two fractional variables is denoted as the split class. A split solution is obtained by dropping the fractional values and maintaining the LP-optimal choices in each class (i.e. the variables with a value equal to 1). If x^{LP} has no fractional variables, then the obtained solution is an optimal solution to the MCKP.

By dropping the fractional values from the LP-relaxation solution, a split solution of value z′ can be used to obtain an upper bound. A heuristic solution to the MCKP with a worst case performance equal to ½ of the optimal solution value can be obtained by taking the maximum of z′ and z^{s}, where z^{s} is the sum of the split substream from the split class, i.e., the stream to which the split substream belongs, and the sum of the qualities of the substreams with the smallest number of required multicast blocks in each of the other components' streams. Since the optimal objective value z* is less than or equal to z′+z^{s}, thus z*<2z^{h} and there is an upper bound on the optimal solution value. The upper bound is used in calculating a scaling factor K for the quality values of the layers. In order to get a performance guarantee of 1−∈, K=∈z^{h}/2S. The quality values are scaled down to q′ₛₗ=└\hat{q}ₛₗ/K┘.

The scaled down instance of the problem can then be solved using dynamic programming by reaching (also known as dynamic programming by profits).

Let B(g, q) denote the minimal number of blocks for a solution of an instance of the substream selection problem consisting of stream components 1, . . . , g, where 1≦g≦2S, such that the total quality of selected substreams is q. For all components g ∈ {1, . . . , 2S} and all quality values q ∈ {0, . . . , 2z^{h}}, a table is constructed in an example where the cell values are B(g, q) for the corresponding g and q. If no solution with total quality q exists, B(g, q) is set to ∞. Initializing B(0, 0)=0 and B(0, q)=∞ for q=1, . . . , 2z^{h}, the values for classes 1, . . . , g are calculated for g=1, . . . , 2S and q=1, . . . , 2z^{h} using the recursion shown in Eq. (2):

$$B ( g , q ) = min \{ \begin{matrix}B ( g - 1 , q - {q}_{g 1} ) + {b}_{g 1} & if 0 \leq q - {q}_{g 1} \\ B ( g - 1 , q - {q}_{g 2} ) + {b}_{g 2} & if 0 \leq q - {q}_{g 2} \\ ⋮ & \\ B ( g - 1 , q - {q}_{{gn}_{g}} ) + {b}_{{gn}_{g}} & if 0 \leq q - {q}_{{gn}_{g}}\end{matrix} \qquad ( 2 )$$

The value of the optimal solution is given by Eq. (3). To obtain the solution vector for the substreams to be transmitted, backtracking from the cell containing the optimal value is performed in the dynamic programming table.

Q*=max{q|B(2S, q)≦P}. (3)

The core component of this example technique is solving the dynamic programming formulation based on the recurrence relation in Eq. (2) above. For the basis step where only a single component of one video stream is considered, only the substream of maximum quality and a number of blocks requirement not exceeding the capacity of the scheduling window is selected. It is assumed for the induction hypothesis case of g−1 components that it is also the case that the selected substreams have the maximum possible quality with a total bit rate not exceeding the capacity. For filling the B(g, q) entries in the dynamic programming table, we first retrieve all B(g−1, q−q_{gl}) entries and add the number of block requirements bsl of corresponding layers to them. According to Eq. (2), only the substream with minimum number of blocks among all entries which result in quality q is chosen. This guarantees that the exactly one substream per component constraint is not violated. Since B(g−1, q) is already minimum, then B(g, q) is also minimum for all q. Therefore, based on the above and Eq. (3), the proposed technique generates a valid solution for the substream selection problem.

Let the optimal solution set to the problem be X* with a corresponding optimal value of z*. Running dynamic programming by profits on the scaled instance of the problem results in a solution set X̅. Using the original values of the substreams chosen in x̅, an approximate solution value z^{A} is obtained. Since the floor operation is used to round down the quality values during the scaling process, the result:

$${z}^{A} = {\sum }_{j ∈ \tilde{X}} {q}_{j} \geq {\sum }_{j ∈ \tilde{X}} K ⌊ \frac{{q}_{j}}{K} ⌋ . \qquad ( 4 )$$

The optimal solution to a scaled instance will always be at least as large as the sum of the scaled quality values of the substreams in the optimal solution set X* of the original problem. Thus, the following chain of inequalities exists:

$${\sum }_{j ∈ \tilde{X}} K ⌊ \frac{{q}_{j}}{K} ⌋ \geq {\sum }_{j ∈ {X}^{*}} K ⌊ \frac{{q}_{j}}{K} ⌋ \geq {\sum }_{j ∈ {X}^{*}} K ( \frac{{q}_{j}}{K} - 1 ) = {\sum }_{j ∈ {X}^{*}} ( {q}_{j} - K ) = {z}^{*} - 2 SK . \qquad ( 5 )$$

Replacing the value of K:

$${z}^{A} \geq {z}^{*} - 2 S \cdot \frac{ε {z}^{h}}{2 S} = {z}^{*} - ε {z}^{h} . \qquad ( 6 )$$

Since z^{h} is a lower bound on the optimal solution value (z^{h}≦z*):

z^{Z}≧z*−∈z*=(1−∈)z*. (7)

This proves that the solution obtained by this technique is always within a factor of (1−∈) from the optimal solution. Therefore, it is a constant factor approximation technique with approximation factor (1−∈).

Minimizing energy consumption is desirable in battery powered mobile wireless devices. Implementing an energy saving scheme which minimizes the energy consumption over all mobile subscribers is therefore beneficial for multicasting video streams over wireless access networks. Instead of continuously sending the streams at the encoding bit rate, a typical energy saving scheme transmits the video streams in bursts. After receiving a burst of data, mobile subscribers can switch off their RF circuits until the start of the next burst. An optimal allocation scheme should generate a burst schedule that maximizes the average system-wide energy saving over all multicast streams. The problem of finding the optimum schedule is complicated by the requirement that the schedule must ensure that there are no receiver buffer violations for any multicast session.

According to an example, the problem is approached by leveraging a scheme known as double buffering in which a receiver buffer of size B is divided into two buffers, a receiving buffer and a consumption buffer, of size B/2. Thus, a number of bursts with an aggregate size of B/2 can be received while the video data are being drained from the consumption buffer. This scheme resolves the buffer overflow problem. To avoid underflow, it is desirable to ensure that the reception buffer is completely filled by the time the consumption buffer is completely drained, and the buffers are swapped at that point in time. Since complete radio frames have a fixed duration, a burst is considered to be composed of one or more contiguous radio frames allocated to a certain video stream.

Let γₛ be the energy saving for a mobile subscriber receiving stream s. γₛ is the ratio between the amount of time the RF circuits are put in sleep mode within the scheduling window to the total duration of the window. The average system-wide energy saving over all multicast sessions can therefore be defined as

$$γ = \frac{1}{S} {\sum }_{s = 1}^{S} {γ}_{s}$$

The objective of an energy efficient allocation technique is thus a list Γ of the form [symbol] nₛ· [symbol] ∫ₛ¹·uₛ¹ [symbol] . . . [symbol] ∫ₛ²·wₛ² [symbol] for each 3D video stream. In this list, nₛ is the number of bursts that should be transmitted for stream s within the scheduling window, and f^{k}ₛ and W^{k}ₛ denote the starting frame and the width of burst k, respectively. Moreover, no two bursts should overlap.

According to an example, substreams are selected using the scalable 3D video multicast (S3VM) technique. It is therefore possible to omit the substream subscripts I from corresponding terms in the following for simplicity, e.g., r^{t}ₛ instead of r^{t}ₛₗ. Let rₛ be the aggregate bit rate of the texture and depth component substreams of video s, i.e., rₛ=f^{t}ₛ+r^{d}ₛ.

For each 3D video stream, the scheduling window is divided into a number of intervals w^{k}ₛ, where k denotes the interval index, during which receiving buffer needs to be filled with B/2 data before the consumption buffer is completely drained. It is to be noted that depending on the video bit rate, the length of the interval may not necessarily be aligned with the radio frames. This means that buffer swapping at the receiver side, which occurs whenever the consumption buffer is completely drained, may take place at any point during the last radio frame of the interval. The starting point of an interval is always aligned with radio frames. Thus, it is necessary to keep track of the current level of the consumption buffer at the beginning of an interval to determine when the buffer swapping will occur and set the deadline accordingly.

Let Y^{k}ₛ denote the consumption buffer level for stream s at the beginning of interval k, and x^{k}ₛ and z^{k}ₛ are the start and end frames for interval k of stream s, respectively. The end frame for an interval represents a deadline by which the receiving buffer should be filled before a buffer swap occurs. Within each interval for stream s, the base station schedules y^{k}ₛ for transmission before the deadline. Except for the last interval, the number of frames to be transmitted is ┌B/2/F┐. The last of the scheduled frames within an interval may not be completely filled with video data. For the last interval, the end time is always set to the end of the scheduling window. The amount of data to be transmitted within this interval is calculated based on how much data will be drained from the consumption buffer by the end of the window.

$$\begin{matrix}{ϒ}_{s}^{k} = \{ \begin{matrix}B / 2 & if k = 0 \\ \frac{B}{2} - ( 1 - \frac{{ϒ}_{s}^{k - 1} mod {r}_{s} τ}{{r}_{s} τ} ) & if {ϒ}_{s}^{k - 1} mod {r}_{s} τ \neq 0 \\ B / 2 & otherwise\end{matrix} & ( 8 ) \\ {x}_{s}^{k} = \{ \begin{matrix}0 & if k = 0 \\ {z}_{s}^{k - 1} & if {ϒ}_{s}^{k - 1} mod {r}_{s} τ = 0 \\ {z}_{s}^{k - 1} + 1 & otherwise\end{matrix} & ( 9 ) \\ {z}_{s}^{k} = \{ \begin{matrix}P & if k is last interval \\ {x}_{s}^{k} + ⌊ \frac{{ϒ}_{s}^{k}}{{r}_{s} τ} ⌋ & otherwise\end{matrix} & ( 10 ) \\ {y}_{s}^{k} = \{ \begin{matrix}⌈ ( \frac{B}{2} - {ϒ}_{s}^{k} ) + {r}_{s} τ ( P - {x}_{s}^{k} ) ⌉ & if k is last interval \\ ⌈ \frac{ B / 2}{F} ⌉ & otherwise\end{matrix} & ( 11 )\end{matrix}$$

Assuming that the consumption buffer is initially full, an allocation extension according to an example proceeds as follows. The start frame number for all streams is initially set to zero. Decision points are set at the start and end frames for each interval of each frame as well as the frame at which all data to be transmitted within the interval has been allocated. At each decision point, the technique picks the interval with earliest deadline, i.e., closest end frame, among all outstanding intervals. It then continues allocating frames for the chosen video until the next decision point or the fulfillment of the data transmission requirements for that interval.

FIG. 4 illustrates transmission intervals and decision points for two data streams according to an example, which demonstrates the concepts of transmission intervals and decision points for a two stream example. Stream-2 in FIG. 4 has a higher data rate. Thus, the consumption buffer for the receivers of the second multicast session is drained faster than consumption buffer of the receivers of the first stream. Consequently, the transmission intervals for stream-2 are shorter. The set of decision points within the scheduling window is the union of the decision points of all streams being transmitted, as shown at the bottom of FIG. 4.

If no feasible allocation satisfying the buffer constraints is returned, the selected substreams cannot be allocated within the scheduling window. Thus, the problem size needs to be reduced by discarding one or more layers from the input video streams and a new set of substreams needs to be recomputed. To prevent severe shape deformations and geometry errors, the layer reduction process is initially restricted in an example to the texture components of the 3D videos. This process is repeated until a feasible allocation is obtained or all enhancement layers of texture components have been discarded. If a feasible solution is not obtained after discarding all texture component enhancement layers, reducing layers from the depth components is proceeded with. Given only the base layers of all components, if no feasible solution is found, the system should reduce the number of video streams to be transmitted. Deciding on the video stream from which an enhancement layer is discarded is based on the ratio between the average quality of synthesized views and size of the video data being transmitted within the window. In an example, the average quality given by the available substreams of each video over all synthesized views is calculated. This value is divided by the amount of data being transmitted within the scheduling window. The video stream with the minimum quality to bits ratio is chosen for enhancement layer reduction.

According to an example, the quality of synthesized intermediate views is compared against the quality of views synthesized from the original non-compressed (source) references (view and depth). These values are then used along with average qualities obtained for the compressed reference texture and depth substreams to obtain the model parameters at each synthesized view position. A typical example would be a 20-MHz Mobile WiMAX channel, which supports data rates up to 60 Mbps depending on the modulation and coding scheme. The typical frame duration in Mobile WiMAX is 5 ms. Thus, for a 1 second scheduling window, there are 200 TDD frames. If the size of the MBS area within each frame is 100 Kb, then the initial multicast channel bit rate is 20 Mbps. Two performance metrics are used in an example in evaluating the technique: average video quality (over all synthesized views and all streams), and running time.

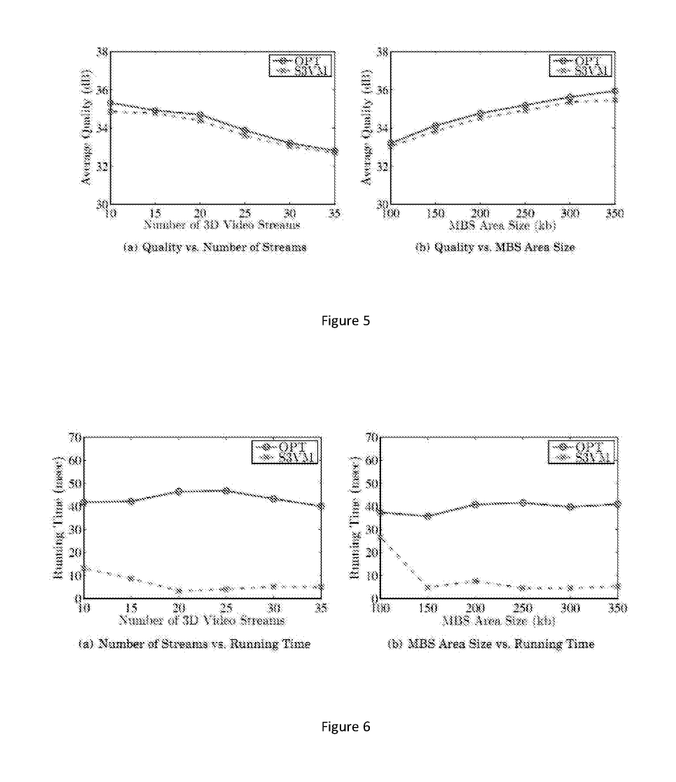

Performance of the technique described above can be assessed in terms of video quality. For example, the MBS area size is fixed at 100 Kb and the number of 3D video streams varied from 10 to 35 streams. The approximation parameter ∈ is set to 0.1. The average quality is calculated across all video streams for all synthesized intermediate views. The results obtained are compared to those obtained from the absolute optimal substream set returned, such as that returned using optimization software for example. The results are shown in FIG. 5a. The average quality of a feasible solution decreases since more video data needs to be allocated within the scheduling window. However, it is clear that this technique returns a near optimal solution with a set of substreams that results in an average quality that is less than the optimal solution by at most 0.3 dB. Moreover, as the number of videos increases, the gap between the solution returned by the S3VM technique and the optimal solution decreases. This indicates that this technique scales well with the number of streams to be transmitted.

The number of video streams is then fixed at 30 and the capacity of the MBS area varied from 100 Kb to 350 Kb, reflecting data transmission rates ranging from 20 Mbps to 70 Mbps. As can be seen from the results in FIG. 5b, the quality of the solution obtained by this technique again closely follows the optimal solution.

The running time can be evaluated against that of finding the optimum solution. For example, fixing the approximation parameter at 0.1 and the MBS area size at 100 Kb, the running time is measured for a variable number of 3D video streams. FIG. 6a compares these results with those measured for obtaining the optimal solution. As shown in FIG. 6a, the running time of the S3VM technique is almost a quarter of the time required to obtain the optimal solution for all samples. In FIG. 6b results for a second experiment where the number of videos was fixed at 30 streams and the MBS area size was varied from 100 Kb to 350 Kb are shown. From FIG. 6b, it is clear that the running time of this technique is still significantly less than that of the optimum solution.

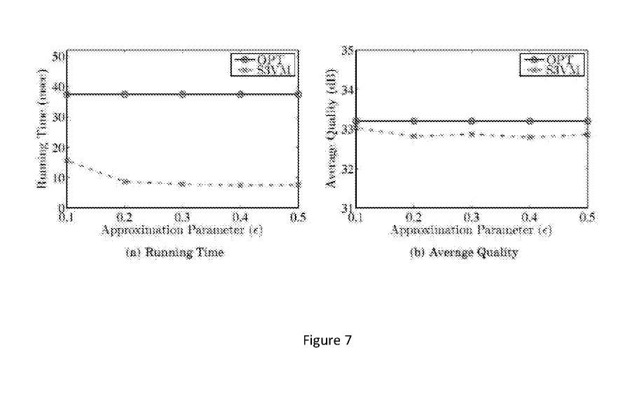

The effect of the approximation parameter value ∈ on the running time can be evaluated. For example, 30 video streams are used with an MBS area size of 100 Kb, with ∈ varying from 0.1 to 0.5. As shown in FIG. 7a, increasing the value of the approximation parameter results in faster running time. In the description of the S3VM technique set out above, the scaling factor K is proportional to the value of ∈. Therefore, increasing ∈ results in smaller quality values which reduces the size of the dynamic programming table and consequently the running time of the technique at the cost of increasing the gap between the returned solution and optimal solution, as illustrated in FIG. 7b.

To evaluate the performance of the allocation technique, a 500 second workload is generated from each 3D video. This is achieved by taking 8 second video streams, starting from a random initial frame, and then repeating the frame sequences. The resulting sequences are then encoded as discussed above. The experiments are performed over a period of 50 consecutive scheduling windows. In a first experiment, it is validated that the output schedule from the proposed allocation technique does not result in buffer violations for receivers. The scheduling window duration is set to 4 seconds and the size of the receivers' buffers to 500 kb. The total buffer occupancy is plotted for each multicast session at the end of each TDD frame within the scheduling window. The total buffer occupancy is calculated as the sum of the receiving buffer level and the consumption buffer level.

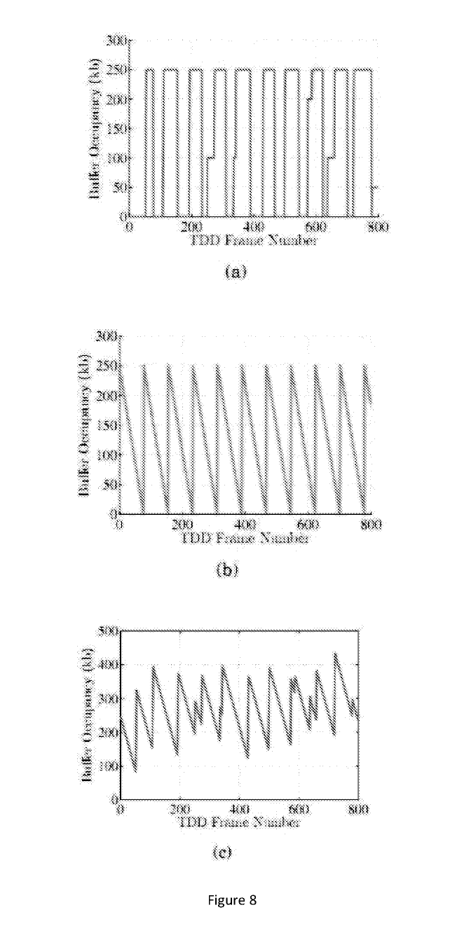

FIG. 8 demonstrates the buffer occupancy for the two buffers as well as the total buffer occupancy for one multicast session according to an example. As can be seen from FIG. 8a, the receiver buffer occupancy never exceeds the buffer size, indicating no buffer overflow instances. For the consumption buffer, its occupancy jumps directly to the maximum level as soon as the buffer becomes empty due to buffer swapping, as shown in FIG. 8b. Similar results were obtained for the rest of the multicast sessions. This indicates that no buffer underflow instances occur.

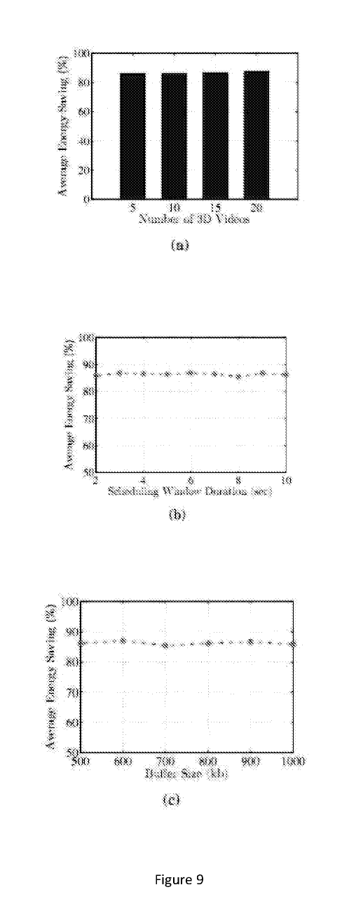

Energy saving performance of the radio frame allocation technique can be evaluated. For example, the power consumption parameters of an actual WiMAX mobile station can be used. In an example, power consumption during the sleep mode and listening mode is 10 mW and 120 mW, respectively. This translates to an energy consumption of 0.05 mJ and 0.6 mJ, respectively, for a 5 ms radio frame. In addition, the transition variable receiver buffer size from the sleep mode to the listening mode consumes 0.002 mJ. The TDD frame size can be set to 150 kb and the receiver buffer size to 500 kb. Using a 2 second scheduling window, the number of multicasted videos can be varied from 5 to 20, and the average power saving over all streams is measured, as shown in FIG. 9a. Next, keeping all other parameters the same, the number of videos is set to 5 and the duration of the scheduling window varied from 2 to 10 seconds. Plotting the average energy savings along with the variance results in the graph shown in FIG. 9b. Finally, in FIG. 9c, the energy saving is shown at different buffer sizes. The number of videos is set to 10, the duration of the window to 2 seconds, and receiver buffer varies in size from 500 to 1000 kb. As can be seen from FIG. 9, a technique according to an example maintains a high average energy saving value, around 86%, over all transmitted streams. In all cases, the measured variance was small.

Embodiments are thus able to leverage scalable coded multiview-plus-depth 3D videos and perform joint texture-depth rate-distortion optimized substream extraction to maximize the average quality of rendered views over all 3D video streams. It has been shown that the technique has an approximation factor of (1−∈). The radio frame allocation technique can be used as an extension to the technique to schedule efficiently the chosen substreams such that the power consumption of receiving mobile devices is reduced without introducing any buffer overflow or underflow instances.

In this description, it is assumed that the 3D video content is represented using multiple texture video stream views, captured from different viewpoints of the scene, and their respective depth map streams. The streams are simulcast coded in order to support real-time service. Scalable video coders (SVCs) that encode video content into multiple layers can be used in an example. These scalable coded streams can then be transmitted and decoded at various bit rates. This can be achieved using an extractor that adapts the stream for the target rate and/or resolutions. The extractor can either be at the streaming server side, at a network node between the sender and the receiver, or at the receiver-side. The base station in a wireless video broadcasting service can be responsible for extracting the substreams to be transmitted according to an example. Each extracted substream can be rendered at a lower quality than the original (complete) source stream. It will be readily appreciated that the techniques described may be applicable to other 3D video content representations.

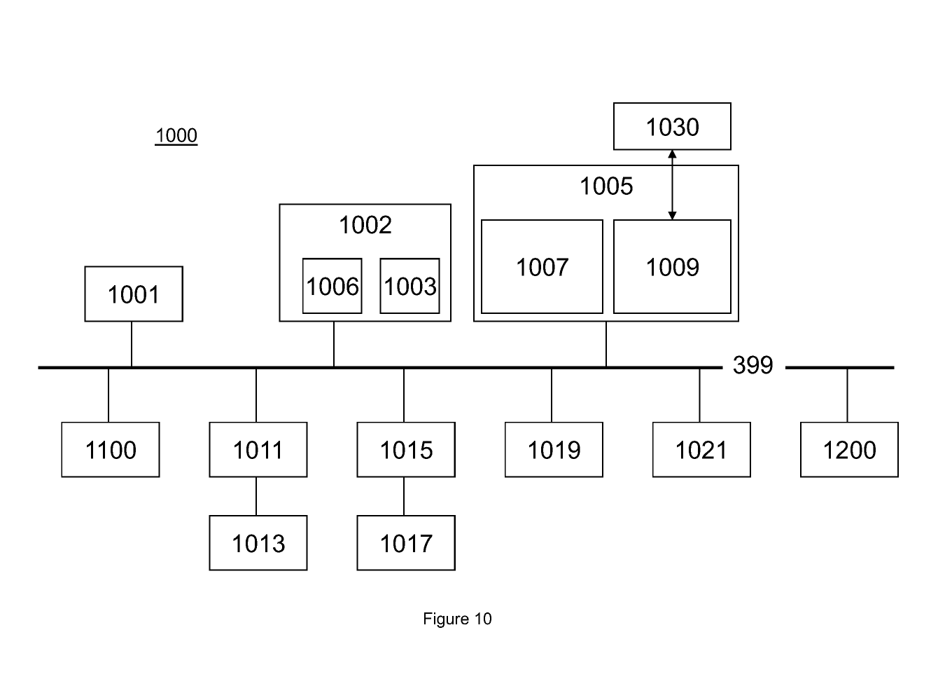

FIG. 10 is a schematic block diagram of an apparatus according to an example. Apparatus 1000 includes one or more processors, such as processor 1001, providing an execution platform for executing machine readable instructions such as software. Commands and data from the processor 1001 are communicated over a communication bus 399. The system 1000 also includes a main memory 1002, such as a Random Access Memory (RAM), where machine readable instructions may reside during runtime, and a secondary memory 1005. The secondary memory 1005 includes, for example, a hard disk drive 1007 and/or a removable storage drive 1030, representing a floppy diskette drive, a magnetic tape drive, a compact disk drive, etc., or a non-volatile memory where a copy of machine readable instructions or software may be stored. The secondary memory 1005 may also include ROM (read only memory), EPROM (erasable, programmable ROM), EEPROM (electrically erasable, programmable ROM). In addition to software, data representing any one or more of video data, such as reference video texture and depth data, depth information such as data representing a depth map for example, and data representing encoded video data may be stored in the main memory 1002 and/or the secondary memory 1005. The removable storage drive 1030 reads from and/or writes to a removable storage unit 1009 in a well-known manner.

A user can interface with the system 1000 with one or more input devices 1011, such as a keyboard, a mouse, a stylus, and the like in order to provide user input data. The display adaptor 1015 interfaces with the communication bus 399 and the display 1017 and receives display data from the processor 1001 and converts the display data into display commands for the display 1017. The display 1017 can be a 3D capable display as described earlier. A network interface 1019 can be provided for communicating with other systems and devices via a network (not shown). The system can include a wireless interface 1021 for communicating with wireless devices in the wireless community.

A wireless transceiver 1100 is provided to wirelessly communicate with multiple recipients (not shown). A control logic 1200 which can be coupled to the wireless transceiver 1100 is used to determine an amount of available bandwidth for multicasting multiple data streams for recipients. The control logic 1200 can select an encoded data stream including data substreams relating to at least first and second video reference views and corresponding depth data for respective ones of the video reference views to transmit to a recipient via the wireless transceiver 1100 on the basis of the determined bandwidth. In an example, apparatus 1000 may be provided with a wireless transceiver 1100 and a control logic 1200 in addition to or in the absence of other elements as described with reference to FIG. 10. For example, certain elements may not be required if the apparatus is part of an infrastructure in which minimal interaction with human operators is required.

Accordingly, it will be apparent to one of ordinary skill in the art that one or more of the components of the system 1000 may not be included and/or other components may be added as is known in the art. The system 1000 shown in FIG. 10 is provided as an example of a possible platform that may be used, and other types of platforms may be used as is known in the art. One or more of the steps described above may be implemented as instructions embedded on a computer readable medium and executed on the system 1000. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running a computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated above may be performed by any electronic device capable of executing the above-described functions.

According to an example, data 1003 representing video data such as a reference view texture or depth stream and/or a substream, such as an encoded substream can reside in memory 1002. The functions performed by control logic 1200 can be executed from memory 1002 for example, such that a control module 1006 is provided which can be the analogue of the control logic 1200.

What is claimed is:

1. Apparatus, comprising:
a wireless transceiver to wirelessly communicate with multiple recipients;
control logic coupled to the wireless transceiver to determine an amount of available bandwidth for multicasting multiple data streams for the recipients, the control logic to select an encoded data stream including data substreams relating to at least first and second video reference views and corresponding depth data for respective ones of the video reference views to transmit to a recipient via the wireless transceiver on the basis of the determined bandwidth.

2. Apparatus as claimed in claim 1, the control logic to select an encoded data stream for transmission in dependence upon an allowable maximum bit rate for a wireless communication link concerned.

3. Apparatus as claimed in claim 1, the control logic to select an encoded data stream for transmission to maximise a measure for the average quality over all synthesised views for a data stream over all data streams being transmitted.

4. Apparatus as claimed in claim 1, further comprising an encoder to scalably encode respective ones of the data substreams to provide multiple encoded substreams, wherein an encoded data stream includes encoded substreams.

5. Apparatus as claimed in claim 4, further comprising an encoder to scalably encode respective ones of the data substreams to provide multiple encoded substreams, wherein an encoded data stream includes encoded substreams, the control logic to multiplex selected encoded data substreams to provide an encoded data stream for a recipient.

6. A method for multicasting multiple video data streams over a wireless network, the method comprising:
encoding respective reference view texture and depth components of a video data stream to provide multiple compressed reference texture and depth substreams for the data stream representing respective different quality layers for the components of the data stream, the reference texture and depth components allowing the synthesis of multiple views for a video data stream which are intermediate to reference views;
determining a maximum data capacity for a channel of the wireless network;
for each video data stream, selecting substreams for reference texture and depth components from the layers which: maximise average quality of the multiple intermediate views according to a predetermined quality metric; maintain a bit rate which does not exceed the maximum data capacity.

7. A method as claimed in claim 6, wherein a predetermined quality metric is computed using a measure representing the distortion in a synthesised view for the video data stream.

8. A method as claimed in claim 6, wherein a predetermined quality metric is computed using a measure representing the distortion in a synthesised view for the video data stream and wherein the measure representing distortion is calculated relative to a synthesised view generated from uncompressed components.

9. A method as claimed in claim 6, wherein a predetermined quality metric is computed using a measure representing the distortion in a synthesised view for the video data stream, the method further comprising:
generating multiple versions of a synthesised intermediate view using respective reference view texture and depth components from the quality layers;
generating the same synthesised intermediate view using uncompressed reference view texture and depth components;
calculating a measure for the quality metric of the synthesised intermediate views by comparing the multiple versions obtained using the compressed components to the version obtained using the uncompressed components.

10. A method as claimed in claim 6, wherein a predetermined quality metric is computed using a measure representing the distortion in a synthesised view for the video data stream, the method further comprising:
generating multiple versions of a synthesised intermediate view using respective reference view texture and depth components from the quality layers;
generating the same synthesised intermediate view using uncompressed reference view texture and depth components;
calculating a measure for the quality metric of the synthesised intermediate views by comparing the multiple versions obtained using the compressed components to the version obtained using the uncompressed components;
determining a luminance value for a portion of a synthesised intermediate view; and
determining a measure representing the structural similarity for a portion of a synthesised intermediate view.

11. A method as claimed in claim 6, wherein the quality of synthesised intermediate views and the quality of uncompressed reference view texture and depth components is approximated by a linear plane.

12. A method as claimed in claim 6, further comprising:
performing burst scheduling such that the average system-wide energy saving over all multicast sessions is maximized.

13. A computer program embedded on a non-transitory tangible computer readable storage medium, the computer program including machine readable instructions that, when executed by a processor, implement a method for multicasting multiple video data streams over a wireless network, comprising:
encoding respective reference view texture and depth components of a video data stream to provide multiple compressed reference texture and depth substreams for the data stream representing respective different quality layers for the components of the data stream, the reference texture and depth components allowing the synthesis of multiple views for a video data stream which are intermediate to reference views;
determining a maximum data capacity for a channel of the wireless network;
for each video data stream, selecting substreams for reference texture and depth components from the layers which: maximise average quality of the multiple intermediate views according to a predetermined quality metric; maintain a bit rate which does not exceed the maximum data capacity.

14. A computer program embedded on a non-transitory tangible computer readable storage medium as claimed in claim 13, the computer program including machine readable instructions that, when executed by a processor implement a method for multicasting multiple video data streams over a wireless network, wherein a predetermined quality metric is computed using a measure representing the distortion in a synthesised view for the video data stream.

15. A computer program embedded on a non-transitory tangible computer readable storage medium as claimed in claim 14, the computer program including machine readable instructions that, when executed by a processor implement a method for multicasting multiple video data streams over a wireless network, wherein the measure representing distortion is calculated relative to a synthesised view generated from uncompressed components.

16. A computer program embedded on a non-transitory tangible computer readable storage medium as claimed in claim 14, the computer program including machine readable instructions that, when executed by a processor implement a method for multicasting multiple video data streams over a wireless network, further comprising:
generating multiple versions of a synthesised intermediate view using respective reference view texture and depth components from the quality layers;
generating the same synthesised intermediate view using uncompressed reference view texture and depth components;
calculating a measure for the quality metric of the synthesised intermediate views by comparing the multiple versions obtained using the compressed components to the version obtained using the uncompressed components.

17. A computer program embedded on a non-transitory tangible computer readable storage medium as claimed in claim 14, the computer program including machine readable instructions that, when executed by a processor implement a method for multicasting multiple video data streams over a wireless network, further comprising:
determining a luminance value for a portion of a synthesised intermediate view; and
determining a measure representing the structural similarity for a portion of a synthesised intermediate view.

18. A computer program embedded on a non-transitory tangible computer readable storage medium as claimed in claim 13, the computer program including machine readable instructions that, when executed by a processor implement a method for multicasting multiple video data streams over a wireless network, wherein the quality of synthesised intermediate views and the quality of uncompressed reference view texture and depth components is approximated by a linear plane.

19. A computer program embedded on a non-transitory tangible computer readable storage medium as claimed in claim 13, the computer program including machine readable instructions that, when executed by a processor implement a method for multicasting multiple video data streams over a wireless network, further comprising:
performing burst scheduling such that the average system-wide energy saving over all multicast sessions is maximized.
